(19) United States
(12) Patent Application Publication
(10) Pub. No.: US 2012/0063175 A1
(43) Pub. Date: Mar. 15, 2012

(54) COMPENSATION CIRCUIT AND METHOD FOR A SYNCHRONOUS RECTIFIER DRIVER

(76) Inventors: Dong WANG, El Segundo, CA (US); Yan-Fei LIU, Kingston (CA)

(21) Appl. No.: 13/228,268

(22) Filed: Sep. 8, 2011

Related U.S. Application Data
(60) Provisional application No. 61/381,681, filed on Sep. 10, 2010.

(51) Int. Cl. H02M 3/335

(52) U.S. Cl. 363/21.14

(57) ABSTRACT

Provided are circuits and methods for driving the synchronous rectifier (SR) of a power converter. A non-linear voltage sense compensator is applied across the drain and source of the SR, and a sense signal is provided to the SR driver sense input, such that false triggering of the SR is effectively eliminated. In addition, the voltage sense compensator ensures that the SR is turned on as soon as its current starts to flow and is turned off when its current falls to zero. The embodiments described herein may be incorporated into new VR designs, or they may be used to improve the SR driving characteristics of commercially available voltage sensing SR drivers.

### RELATED APPLICATION

This application claims the benefit of the filing date of U.S. Provisional Patent Application No. 61/381,681, filed on 10 Sep. 2010, the contents of which are incorporated herein by reference in their entirety.

### FIELD OF THE INVENTION

This invention relates to circuits and methods for improving the efficiency of a driver for a synchronous rectifier of a power converter.

### BACKGROUND

As demand for low voltage, high output current power converters with high efficiency increases, the LLC resonant converter with synchronous rectifier (SR) is a promising solution. A challenge in the design of such converters is the need to precisely synchronize the driving signal of the SR with the current through the rectifier.

Due to the phase shift introduced by the resonant components, the secondary side currents of the LLC resonant converter are not exactly in phase with the switching of the primary side MOSFETs [3, 4]. To generate an accurate driving signal for the secondary side SR, current-based methods [5-7] and voltage based methods [1, 3, 4] have been suggested.

Current based methods detect current through the SR to generate the gate drive signal [5, 8]. Drawbacks of this approach include the large size of the current-sensing transformer (CT), the extra conduction loss of the winding, and the undesired delay that causes duty cycle loss of the SR and therefore more conduction loss [4, 5, 7]. To avoid such problems, primary current sensing with magnetizing current cancellation was proposed in [5] and [7]. Efficiency of the circuit may be improved because of the relatively smaller primary current of the transformer through the CT. However, the CT and the matching circuits of the transformer magnetizing current make the implementation complex. Matching of the magnetizing current with the inductor or the transformer is also difficult.

Voltage based methods are preferred due to their overall simplicity, lower cost, and efficient operation. Voltage based methods detect the voltage across the drain to the source (v_{DS}) of the SR to generate the driving signal. Driving chips have been developed based on this method to simplify the SR driving. However, due to the small R_{ds}_{_{—}}ₒₙ of the MOSFET, the voltage range of the detecting threshold is at the millivolt level. Thus even very minor ringing caused by the parasitic parameters of the SR device and the overall circuit may result in a false gate driving signal which causes undesired circulating energy loss. Moreover, the sensed v_{DS} of the MOSFET is actually the sum of the R_{ds}_{_{—}}ₒₙ voltage drop and the package's inductive voltage drop. The sensed v_{DS} external to the SR does not accurately represent the Vds seen by the actual SR semiconductor device buried within the package of the SR. A nanoHenry (nH) inductance introduced by a printed circuit board (PCB) trace may cause a considerable duty cycle loss [4]. Therefore, the SR will be on for a much shorter time than required, resulting in extra conduction loss.

The conventional DC resistance of the inductor (DCR) current sensing method is widely used to sense and emulate the current of in voltage regulators (VRs) [9-11]. The advantages of this method are that it utilizes the parasitic DCRs of the inductors and is intrinsically lossless [12-14]. In [4], it was attempted to use DCR current sensing to compensate for the duty cycle loss caused by the trace inductance of the MOSFET package (i.e., the parasitic inductance of the conductors in the package). However, because of the large number of switches used in the matching circuit, the compensator was extremely complicated and difficult to implement. In addition, active switches degrade the reliability of the power circuit, and false-triggering caused by parasitic ringing was not solved.

### SUMMARY

Described herein are circuits and methods for improving characteristics (e.g., efficiency) of driving the synchronous rectifier (SR) of a power converter, based on a v_{DS} sensing scheme. The embodiments described herein may be incorporated into new VR designs, or they may be used to improve the SR driving characteristics of commercially available voltage sensing SR drivers.

As described herein, by applying a voltage sense compensator across the drain and source of the SR, an improved sense signal is provided to the SR driver sense input, and false triggering of the SR may be effectively eliminated. In addition, the voltage sense compensator also ensures that the SR MOSFET will be turned on as soon as its current starts to flow and is turned off when its current falls to zero.

In one embodiment the voltage sense compensator includes a diode or other non-linear device, a resistor, and a capacitor. The resistor and capacitor serve two purposes. One is to filter out ringing caused by leakage inductance of the transformer and the output capacitor of the SR MOSFET. The other purpose is to compensate for the time delay caused by the trace inductance inside the SR MOSFET package and the R_{Ds}_{_{—}}ₒₙ of the SR MOSFET. The diode is used to quickly discharge the voltage across the capacitor when the SR MOSFET is off so that the SR can be turned on as soon as its current starts to flow. Embodiments may include only passive components, making them reliable and easy to implement. Other embodiments may include active components.

Described herein is a method for improving a driving signal of a driver for a synchronous rectifier (SR) of a power converter, comprising: connecting a non-linear compensation circuit in parallel with the SR; sensing a voltage of the non-linear compensation circuit; and outputting the sensed voltage to the SR driver; wherein the SR driver generates a driving signal for the SR based on the sensed voltage. The driving signal for the SR may substantially prevent false-triggering of the SR. The method may include selecting parameters of the resistor and the capacitor to match a trace inductance L_{trace} and R_{DS}_{_{—}}ₒₙ of the SR. The method may include at least partially integrating the non-linear compensation circuit with the SR driver.

The non-linear circuit may compensate voltage across the SR. The non-linear compensation circuit may be a passive circuit. In one embodiment the non-linear compensation circuit may comprise: a capacitor having a first terminal connected to a first terminal of the SR; and a combination of a diode and a resistor connected in parallel at first and second nodes, the first node connected in series with a second terminal of the capacitor and the second node connected to a second terminal of the SR.

The SR may be a device selected from a MOSFET, a MESFET, and a JFET. In one embodiment, the SR is a MOSFET. The resonant converter may be a LLC resonant converter, a series resonant converter, or a flyback converter. The SR driver may be a conventional SR driver.

Also described herein is a circuit for use with a synchronous rectifier (SR) driver of a power converter, comprising: a non-linear compensation circuit connected across the SR; wherein a voltage of the non-linear compensation circuit is outputted to the SR driver and used by the SR driver to generate a driving signal for the SR. The non-linear compensation circuit may be passive.

In one embodiment the non-linear compensation circuit comprises: a capacitor having a first terminal connected to a first terminal of the SR; and a combination of a diode and a resistor connected in parallel at first and second nodes, the first node connected in series with a second terminal of the capacitor and the second node connected to a second terminal of the SR. The SR may be a device selected from a MOSFET, a MESFET, and a JFET. In one embodiment the SR is a MOSFET.

Parameters of the resistor and the capacitor may be selected to match a trace inductance L_{trace} and R_{DS}_{_{—}}ₒₙ of the SR. The driving signal for the SR may substantially prevent false-triggering of the SR.

The resonant converter may be a LLC resonant converter, a series resonant converter, or a flyback converter. The SR driver may be a conventional SR driver. The non-linear compensation circuit may be at least partially integrated with the SR driver.

Also described herein is a synchronous rectifier (SR) for a resonant converter, comprising: a switch; and a non-linear compensation circuit including a capacitor having a first terminal connected to a first terminal of the switch; and a combination of a diode and a resistor connected in parallel at first and second nodes, the first node connected in series with a second terminal of the capacitor and the second node connected to a second terminal of the switch. The synchronous rectifier may also include a SR driver, wherein a voltage of the non-linear compensation circuit is used by the SR driver to generate a SR driving signal. The SR driver may be a conventional SR driver. The switch may be a device selected from a MOSFET, a MESFET, and a JFET. In one embodiment, the switch is a MOSFET.

### DESCRIPTION OF THE DRAWINGS

For a more complete understanding of the invention, and to show how it may be carried into effect, embodiments are described herein with reference to the accompanying drawings, wherein:

FIG. 1 is a diagram of a MOSFET showing its body diode and intrinsic drain to source capacitance;

FIG. 2(a) is a block diagram of a conventional SR driver circuit;

FIG. 2(b) is a circuit diagram of an example of a conventional half-bridge LLC resonant converter with SRs;

FIGS. 2(c) and 2(d) show key waveforms of the LLC converter of FIG. 2(b) operated under full load and light load conditions, respectively;

FIG. 3(a) is a circuit diagram showing v_{DS} sensing with a RC filter;

FIG. 3(b) shows an equivalent circuit of the circuit of FIG. 3(a) during body diode conduction;

FIG. 3(c) shows key waveforms of the circuit of FIG. 3(a);

FIG. 4 shows the equivalent circuit of an SR MOSFET when it is on;

FIG. 5(a) is a block diagram showing connection of a non-linear compensation circuit as described herein between the SR MOSFET and the SR driving circuit;

FIG. 5(b) is a circuit diagram of a half-bridge LLC resonant converter with SRs and non-linear compensation circuit according to one embodiment, wherein the transformer leakage inductance and the MOSFET body diodes and intrinsic drain to source capacitances are shown;

FIG. 5(c) is a circuit diagram of a half-bridge LLC resonant converter with SRs and non-linear compensation circuit according to another embodiment, wherein the transformer leakage inductance and the MOSFET body diodes and intrinsic drain to source capacitances are not shown;

FIG. 5(d) is a circuit diagram of a series resonant converter with SRs and non-linear compensation circuit according to another embodiment, wherein the MOSFET body diodes and intrinsic drain to source capacitances are not shown;

FIG. 5(e) is a circuit diagram of a flyback converter with SR and non-linear compensation circuit according to another embodiment, wherein the MOSFET body diodes and intrinsic drain to source capacitances are not shown;

FIG. 6(a) is a schematic diagram of a non-linear compensation corresponding one embodiment, shown for the case when the SR is turned on;

FIG. 6(b) is an equivalent circuit of the embodiment of the non-linear compensation circuit shown in FIG. 6(a) where the on resistor of the SR MOSFET (R_{DS}_{_{—}}ₒₙ) and trace inductance associated with SR MSOFET (L_{trace}) are shown;

FIGS. 7(a) and 7(b) show a voltage matching method for the embodiment of FIG. 5(b). FIG. 7(a) shows key waveforms of the SR, and FIG. 7(b) is a vector diagram of voltage matching;

FIGS. 8(a) to 8(c) show key operation modes of the embodiment of FIG. 6;

FIGS. 9(a) and 9(b) show key waveforms of the embodiment of FIG. 6 under full and light load conditions, respectively;

FIGS. 10(a) to 10(d) show simplified diagrams of various embodiments in which the non-linear compensation circuit is implemented separately from the SR driving circuit (FIG. 10(a)), partially included with the SR driving circuit (FIGS. 10(b) and 10(c)), and fully included with the SR driving circuit (FIG. 10(d));

FIG. 11 shows results of a simulation of an embodiment corresponding to FIG. 5(b). Shown are v_{DS}, i_{Ls} and the current through the non-linear compensation circuit;

FIG. 12 shows results of experimental measurement of an embodiment corresponding to FIG. 5(b) under full load;

FIG. 13 shows results of experimental measurement of an embodiment corresponding to FIG. 5(b) under light load; and

FIG. 14 is a plot comparing efficiency of simulated embodiments with and without a non-linear compensation circuit.

### DETAILED DESCRIPTION OF EMBODIMENTS

A challenge in the design of resonant converters is the need to precisely synchronize the driving signal of the SR with the current through the rectifier. To generate an accurate driving signal for the secondary side SR, accurate current or voltage sensing is required. However, a problem in designing such converters is that the resonance of the circuit prevents highly accurate voltage sensing. The non-linear compensation circuits and methods described herein overcome this problem.

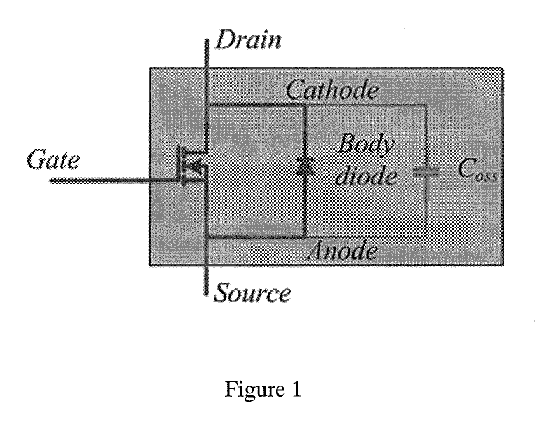

FIG. 1 is an equivalent circuit of a typical MOSFET showing its body diode and intrinsic drain to source capacitance Cₒₛₛ. Although embodiments are described herein primarily with respect to MOSFETs as SRs, it will be appreciated that other switching devices may be used, such as, for example, MESFETs and JFETs.

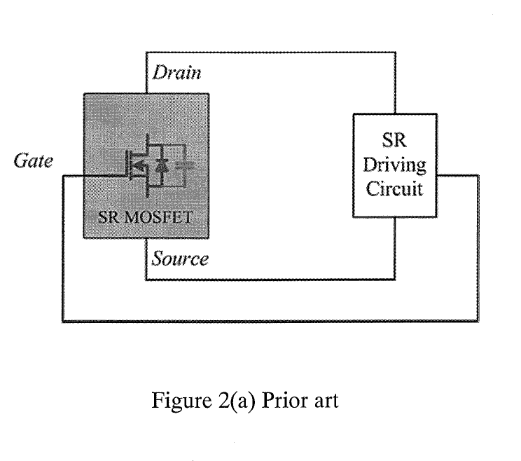

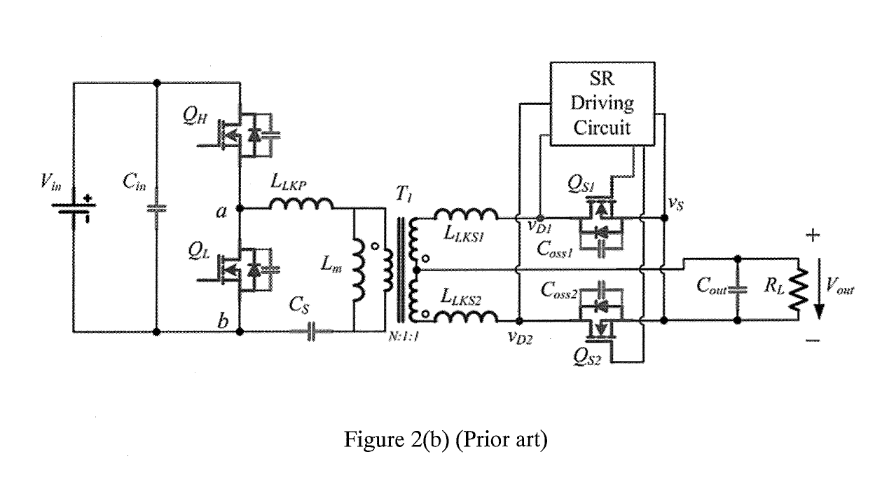

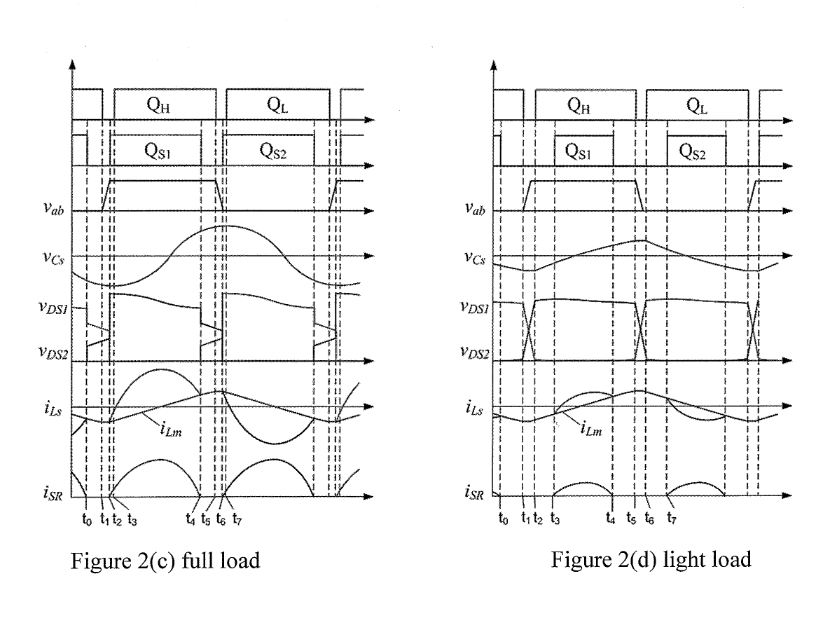

FIG. 2(a) is a block diagram of a conventional SR driver circuit, wherein the driving circuit is connected directly across the drain and source of the SR MOSFET. FIG. 2(b) is a circuit diagram of a conventional half-bridge LLC resonant converter with SRs. MOSFETs Q_{H}, Q_{L}, Q_{S1}, and Q_{S2} are shown with their body diodes and intrinsic output (drain-source) capacitances. Cₒₛₛ₁/and Cₒₛₛ₂ are the output capacitances of the SRs Q_{S1} and Q_{S2}. L_{LKP} is the primary side leakage inductance of the transformer. L_{LKS1} and L_{LKS2} are the secondary leakage inductances. FIGS. 2(c) and 2(d) show key waveforms of the LLC converter when operated in full load and light load conditions, respectively. The primary side driving signals cannot be applied to the SRs because of nonlinear characteristics. To drive the SRs, the v_{DS} of the SRs may be used to approximate acceptable drive signals.

As shown in FIGS. 2(c) and 2(d), there is a small interval when both of the SR MOSFETs turn off (t₄˜t₆ in FIG. 2(c) and t₄˜t₇ in FIG. 2(d)). When the SRs turn off, L_{LKP}, L_{LKS1} and L_{LKS2} resonate with the output capacitance (Cₒₛₛ) of the SRs. The voltage v_{DS2} has high frequency spikes when Q_{S1}/turns off. If the voltage spikes reach the SRs turn on threshold, the SRs will be false-triggered. This results in an energy reversal from the output capacitor to the input source, and may result in breakdown of the power circuit.

As used herein, the term “false triggering” refers to turning on or turning off a switch (e.g., a MOSFET) at an inappropriate or non-ideal time. Such unwanted switching of the SR may waste energy and may be potentially destructive to the converter.

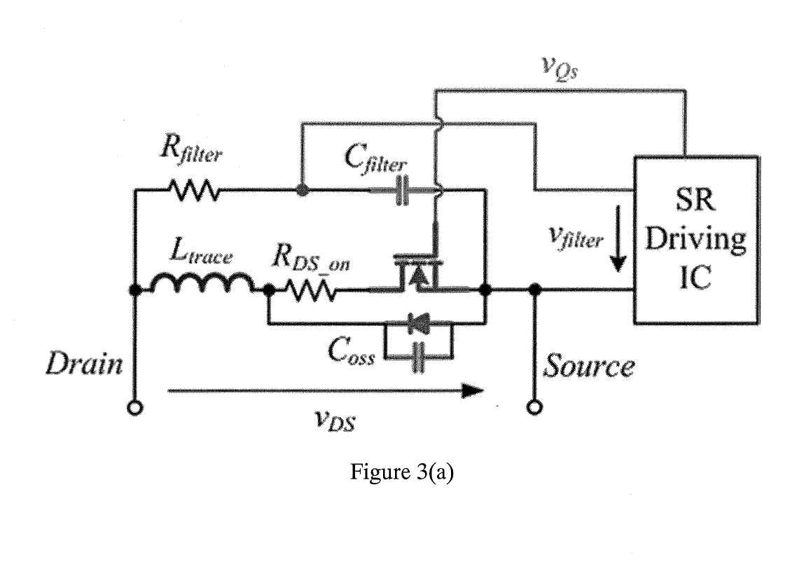

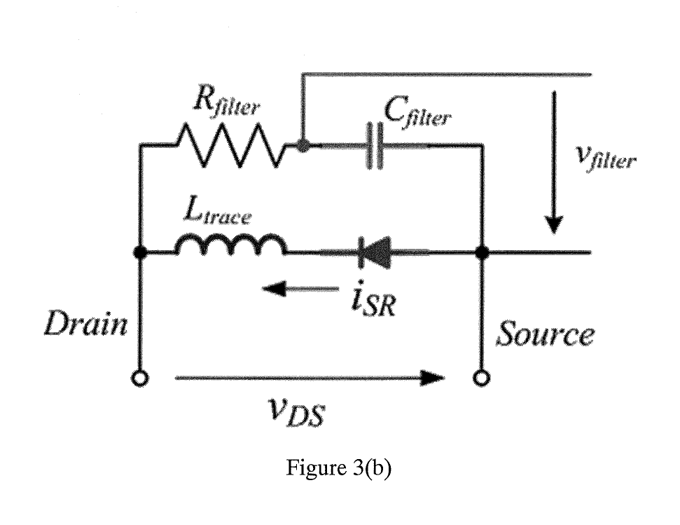

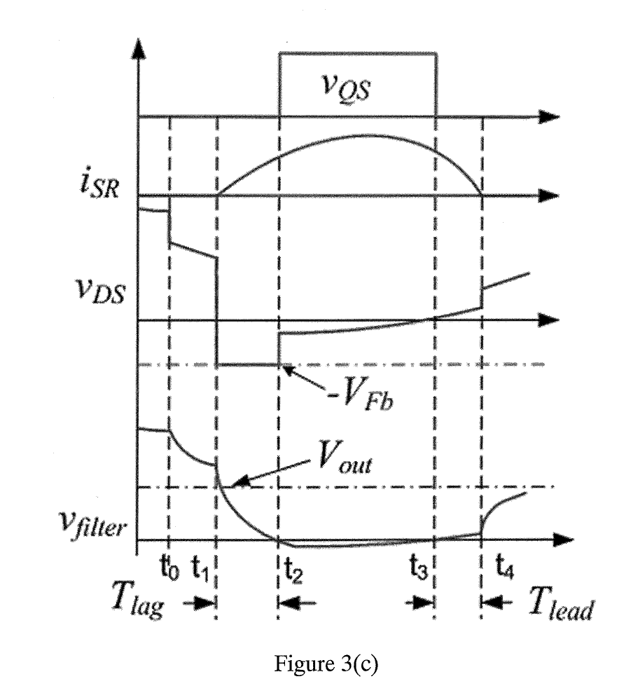

One solution to prevent false-triggering at turn-on of the SRs is to add an RC filter to absorb the voltage spikes of v_{DS}. The filter may be used as a substitute for v_{DS}, and sensed by the driving IC to generate the gate signal. Such a circuit is shown in FIG. 3(a). The equivalent circuit when the SR MOSFET diode is on is shown in FIG. 3(b) and key waveforms are shown in FIG. 3(c).

Due to the high frequency of the voltage spikes, the time constant of the RC filter should be very small, but should be selected a little larger than the period of the parasitic ringing. For example, a time constant of about 100 ns may eliminate false-triggering of the MOSFET. However, the driving signal of the SR may have an unacceptably long lag time at turn on of the SR MOSFET and a long lead time at turn off of the SR MOSFET, which will cause considerable conduction loss of the SR body diode. The reason for the delay at turn on of the SR MOSFET is that the capacitor in the RC filter sustains a high positive voltage before the body diode conducts, and then discharges slowly to the turn-on threshold (less than 0V) through resistor R_{filter}. When the body diode of the SR starts to conduct, the detected v_{filter1} is larger than the output voltage Vₒᵤₜ at t₁. During t₁˜t₂, the body diode of Q_{S1} is forward biased and clamps the v_{DS1} to the forward voltage of the body diode −V_{Fb}. Corresponding to the time constant of the RC filter, V_{filter} starts to decrease to the turn on threshold slowly.

As to the lead time at turn off, the impedance of Cₒₛₛ is much larger than the R_{Ds}_{_{—}}ₒₙ and can be neglected; therefore, only the trace inductance of the SR package should be taken into account. The current through the SR can be treated as part of a sinusoid waveform, and the frequency of the sinusoid waveform is equal to the series resonant frequency of the resonant tank. Because of the trace inductance, the voltage v_{DS} leads the current i_{SR}. If v_{DS} is detected directly to generate the driving signal of SR, the duty cycle loss is inevitable.

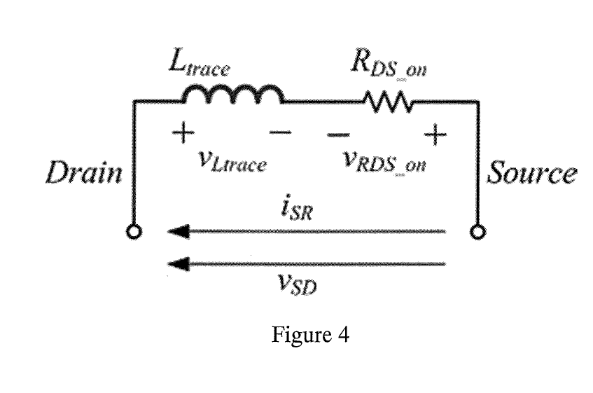

FIG. 4 shows the equivalent circuit of the SR MOSFET when it is on. L_{trace} is the trace inductance inside the SR MOSFET package and R_{Ds}_{_{—}}ₒₙ is the on resistance of the SR MOSFET. The measured voltage at the MOSFET terminal is the sum of voltage across L_{trace} and across R_{DS}_{_{—}}ₒₙ,

V_{SD}=V_{RDS}_{_{—}}ₒₙ−V_{Ltrace}=i_{SR}*R_{DS}_{_{—}}ₒₙ

The SR current i_{SR} is approximately a sinusoidal waveform. When the SR current decreases towards zero, the trace inductance will induce a negative voltage to prevent the SR current from falling. The actual polarity is shown in FIG. 4.

In order to reduce the size of the power supply, the switching frequency of the converter should be increased. When frequency increases, the negative voltage also increases and therefore, the actual current at which V_{SD} equals zero will increase. Thus, if V_{SD} is used to determine the turn off time of the SR MOSFET, the body diode of the SR MOSFET will be conducting and extra loss will be introduced. The higher the switching frequency is, the higher the body diode current will be and therefore, the higher the body diode conduction loss will become. If the switching frequency is reduced, then the body diode current will be reduced.

As described herein, the turn-on delay problem may be solved by adding a non-linear compensation circuit. The purpose of the non-linear compensation circuit is to provide a more accurate switch timing signal to the SR driver circuit. The SR driver circuit operates on the principle that measuring V_{DS} from the SR MOSFET directly provides adequate switch timing However, this is not the case. Measurements of V_{DS} made externally to the packaged MOSFET device deviate from the ideal case due to stray elements in the MOSFET package, as well as in other elements, that degrade the accuracy of the externally sensed V_{DS}. Examples of such elements include L_{trace}, R_{DS}_{_{—}}ₒₙ, and the drain to source capacitance. Use of such externally sensed V_{DS} causes the SR driver circuit to generate a SR switch timing signal that switches the MOSFET at non-optimal timing (also referred to herein as false triggering).

The non-linear compensation circuit is referred to herein as “non-linear” because it includes a component that has a non-linear current-voltage characteristic. Such a component has a semiconductor junction (e.g., a diode or a transistor). The non-linear compensation circuit is asymmetrical in that it provides for different compensation mechanisms for the “on switch event” and for the “off switch event”. During MOSFET turn on, the non-linear compensation circuit compensates the effect of resonant ringing between the leakage inductance of the transformer winding and the output capacitance of the MOSFET at the drain, which causes an oscillatory signal which can falsely trigger the on switch event. During MOSFET turn off, the non-linear compensation circuit compensates for the delay caused by the trace inductance L_{trace} inside the MOSFET package and the on resistor R_{Ds}_{_{—}}ₒₙ of the MOSFET.

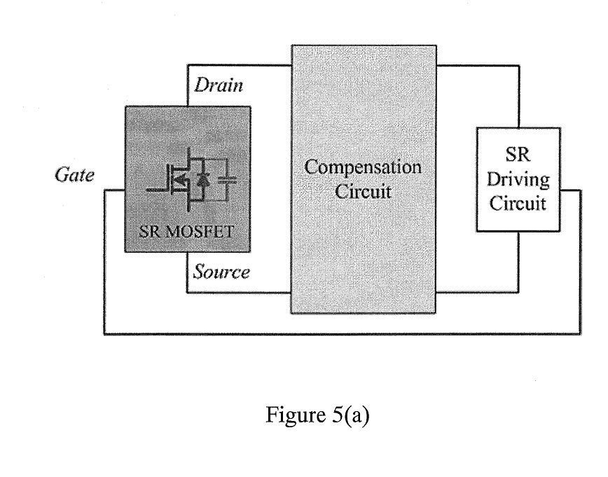

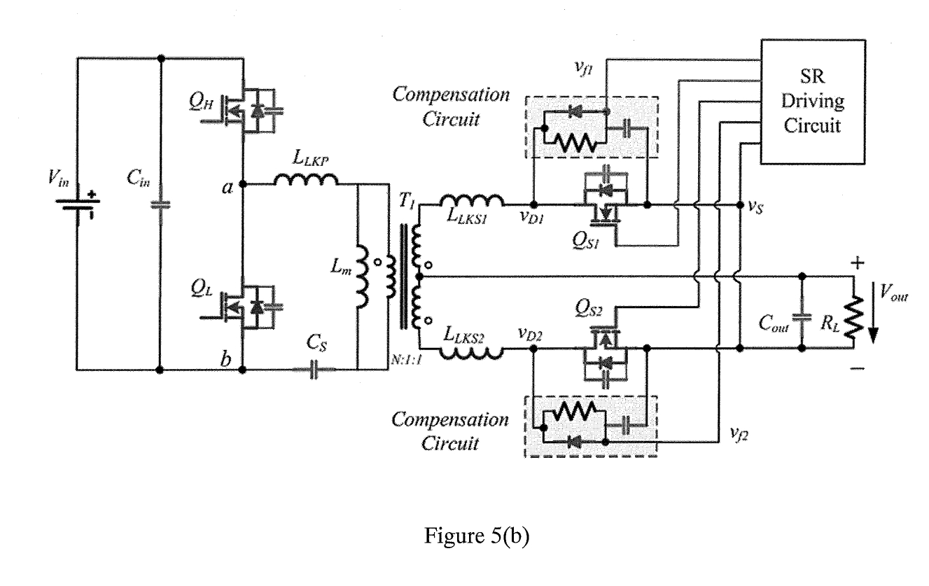

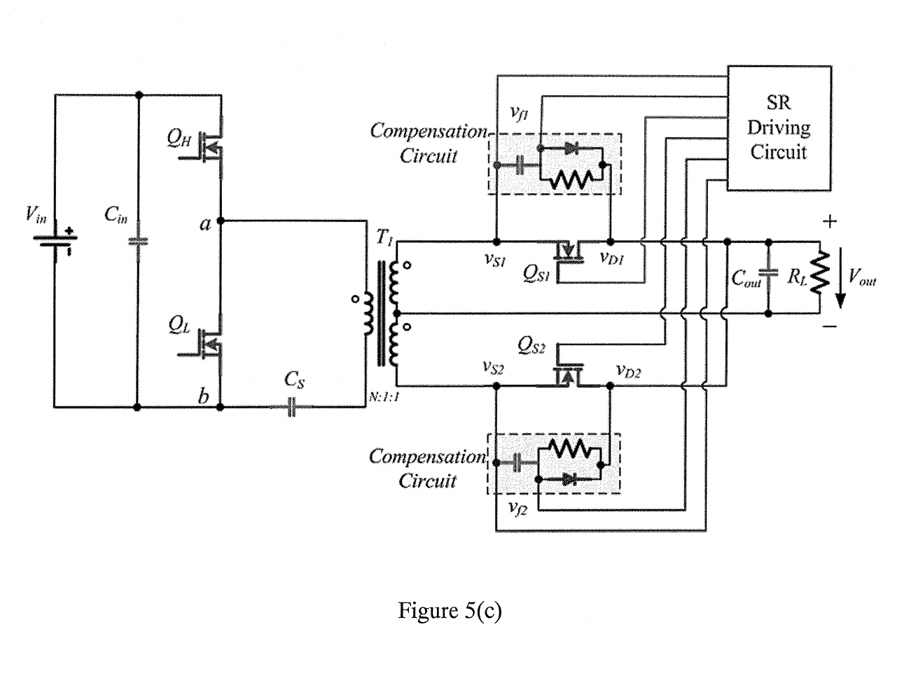

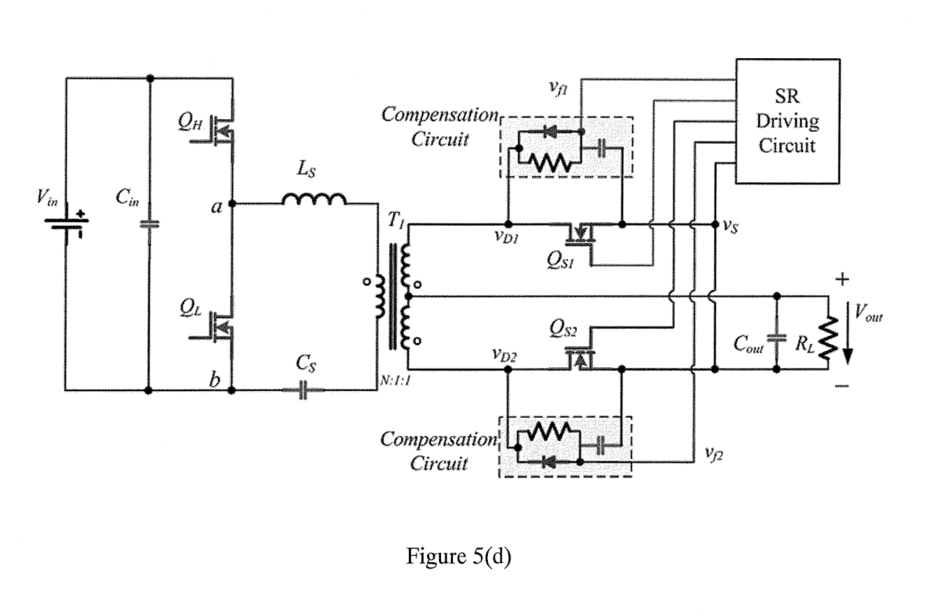

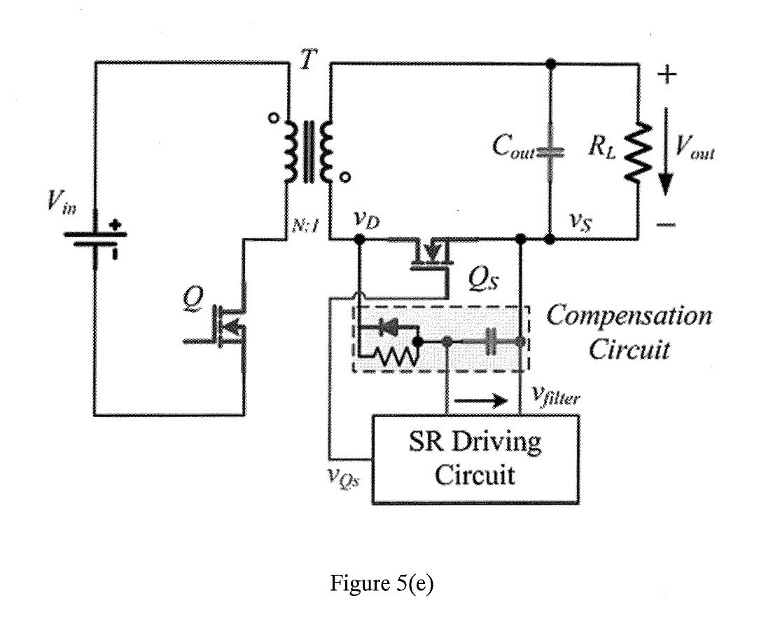

As shown in the block diagram of FIG. 5(a), such a non-linear compensation circuit may be connected between the SR device and the SR driving circuit. For example, FIG. 5(b) shows a circuit diagram of an embodiment wherein the non-linear compensation circuit is applied to the SRs of a half-bridge LLC resonant converter, where components common to the circuit of FIG. 2(b) have the same label. Generally, the non-linear compensation circuit may be applied to other power circuits wherein a synchronous rectifier is turned on and/or turned off using a voltage sensing technique, wherein voltage across the rectifier is sensed. For example, the non-linear compensation circuit may be applied to other power converters, such as, but not limited to, a series resonant converter and a flyback converter, as shown in the embodiments of FIGS. 5(d) and 5(e), respectively. In addition, the non-linear compensation circuit may be applied to power converters used in applications including, for example, motor controllers, fluorescent lamp ballasts, etc. The embodiments shown in FIGS. 5(b), 5(d), and 5(e) are suitable for low side SR drivers. It will be appreciated that these embodiments can easily be implemented for high side SR drivers by appropriate connection of transformer secondary side and SR MOSFET. See, for example, FIG. 5(c) which shows the embodiment of FIG. 5(b) configured as a high side driver.

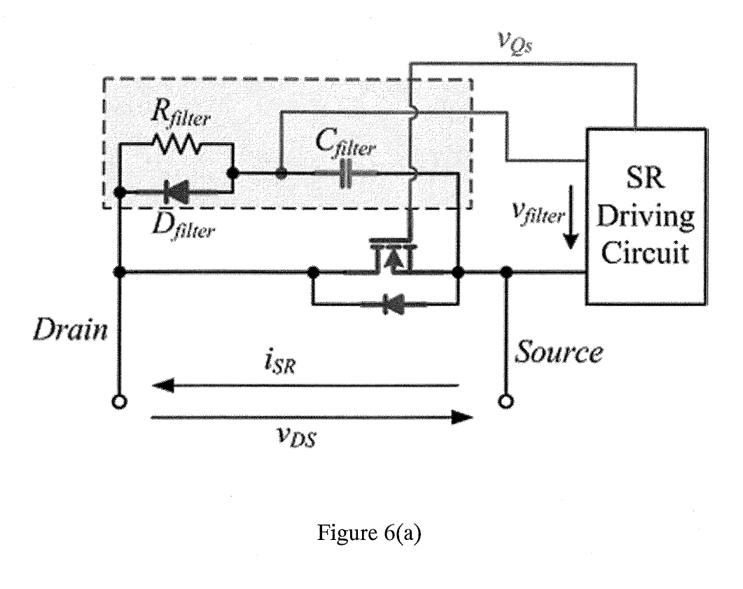

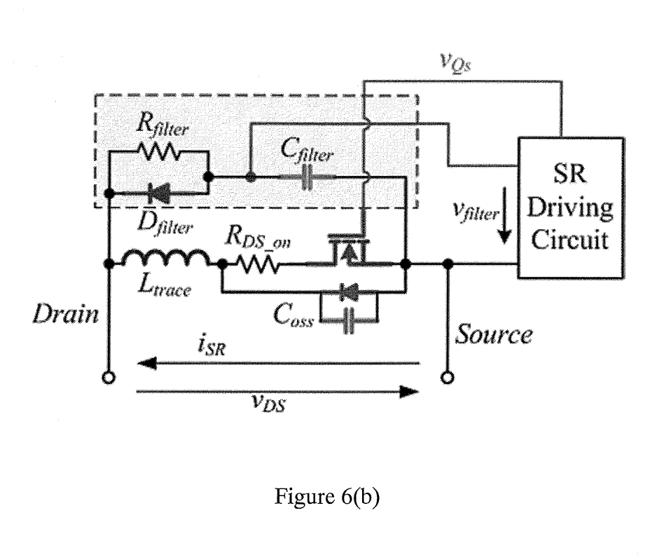

The circuit operation will be described in detail with reference to the embodiment of FIG. 5(b). In FIG. 5(b), v_{f1}/and v_{f2} are sensed by the SR driving circuit as substitutes for V_{D1} and v_{D2}. The non-linear compensation circuit, as shown in the embodiment of FIG. 6(a), includes an anti-parallel diode D_{filter} to discharge the RC filter capacitor quickly. In other embodiments the diode may be replaced with a device that effectively operates like a diode. For example, the diode may be replaced with switch such as a FET or a bipolar transistor, provided that a suitable timing signal is used to control the switch so as to discharge the capacitor at the appropriate time. The equivalent circuit of this embodiment is shown in FIG. 6(b), which also shows the body diode, drain to source capacitance Cₒₛₛ, R_{DS}_{_{—}}ₒₙ, and L_{trace}, of the SR MOSFET. The forward voltage of D_{filter} (V_{FD}) is selected to be a little larger than that of the body diode of the SR (V_{Fb}). In some embodiments two or more diodes may be connected in series if this condition cannot be met by a single diode.

The value of R_{filter} and C_{filter} should selected so that the noise caused by the leakage inductance of the transformer and the output capacitor of the SR MOSFET can be removed. A commonly used method is to select the R_{filter} and C_{filter} value so that the following relation is satisfied:

$${R}_{filter} {C}_{filter} > 2 π \cdot \sqrt{( \frac{{L}_{LKP}}{{N}^{2}} + \frac{{L}_{LKS}}{2} ) \cdot 2 {C}_{oss}} \qquad ( 1 )$$

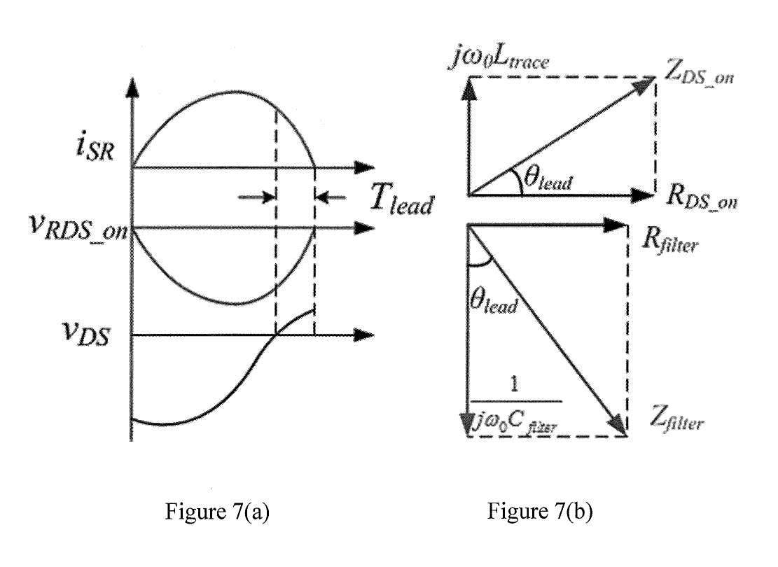

To compensate the lead time at the switch off of the SR, methods known in the art may be employed. For example, a DCR current sensing method may be applied. Parameters of the non-linear compensation circuit should be selected to match the trace inductance L_{trace} R_{Ds}_{_{—}}ₒₙ of the SR. For example, as shown in FIGS. 7(a) and 7(b), the parameters of the filter may be chosen to emulate the lead angle θ_{lead} so that the voltage across the C_{filter} substantially corresponds to V_{RDS}_{_{—}}ₒₙ. The parameters of the filter may be defined as

$${R}_{filter} {C}_{filter} = \frac{{L}_{trace}}{{R}_{DS \_ on}} \qquad ( 2 )$$

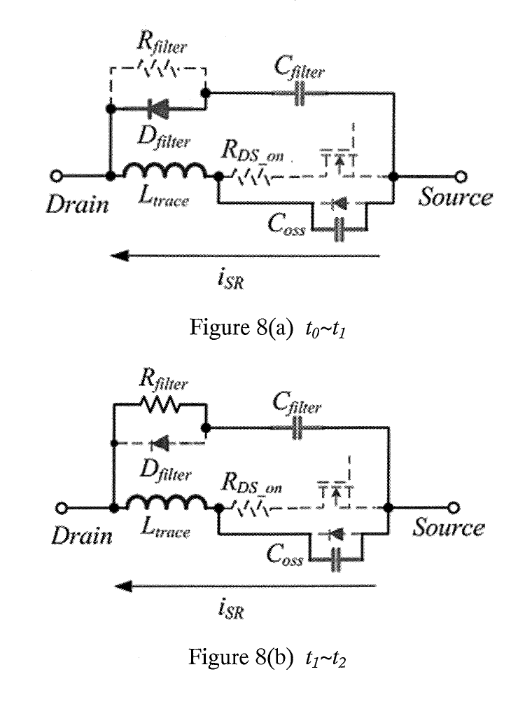

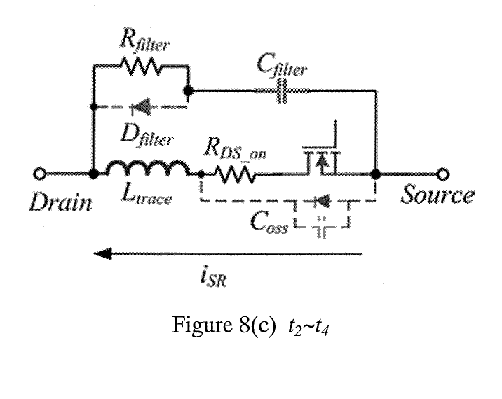

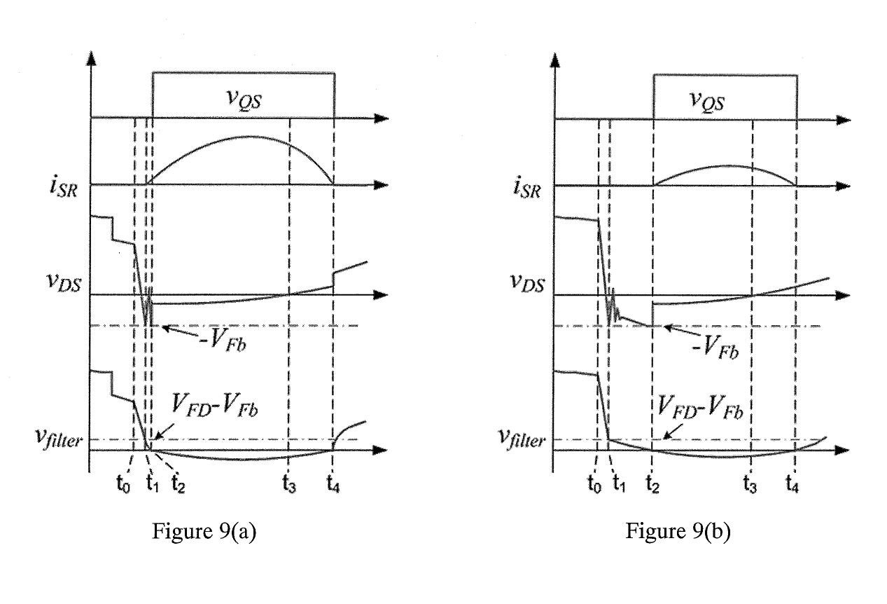

Equivalent circuit diagrams of the non-linear compensation circuit embodiment of FIG. 5(a) in various operation modes are shown in FIGS. 8(a) to 8(c). Key waveforms under full and light load conditions are illustrated in FIGS. 9(a) and 9(b), respectively. In these figures it is assumed that Q_{H} is OFF and Q_{L} is ON before t₀. Operation of the circuit may be described as follows, with reference to FIGS. 9(a) and (b):

1. Before t₀, all of the SRs are turned off. There is only the magnetizing current discharging the resonant capacitor. At t₀, the primary MOSFET Q_{L} turns off. The voltage across the SR decreases quickly, and reaches the forward voltage drop V_{Fb} of the SR body diode at t₁. At the same time, C_{filter} is discharged through D_{filter} until the voltage across C_{filter} equals V_{FD}−V_{Fb}, wherein V_{FD} is the forward voltage drop of D_{filter}.

2. At t₁, due to Cₒₛₛ of the SR, the voltage v_{DS} has high frequency ringing (as explained above). The peak voltage of the ringing is limited by the forward voltage drop V_{Fb} of the SR body diode. Meanwhile, R_{filter} and C_{filter} together operate like a RC filter and filter out the high frequency ringing.

3. Before t₂, the body diode of Q_{S1}/is forward biased and clamps v_{DS} to −V_{Fb}. At t₂, the voltage across C_{filter} v_{filter} reaches the turn on threshold of the driving IC and the driving signal is generated. During t₂˜t₄, R_{filter} and C_{filter} together operate like a traditional DCR current sensing circuit to emulate the current through the SR. At t₄, the voltage v_{filter} reaches the turn off threshold of the driving chip. The SR is turned off.

There are two conditions for the non-linear compensation circuit to emulate the current through the SR. One is that the parameters of R_{filter} and C_{filter} are selected to match the trace inductance L_{trace} and R_{DS}_{_{—}}ₒₙ of the SR, as shown in equation (2). The other is that the initial voltage v_{filter} is zero volts. Due to the design parameters of R_{filter} and C_{filter} as well as the small value between V_{FD}−V_{Fb} and the turn on threshold, both of these conditions may be met. In addition, the false-triggering immunity of the non-linear compensation circuit is retained. Consequently, reliability of the SR circuit is improved and conduction loss is significantly reduced.

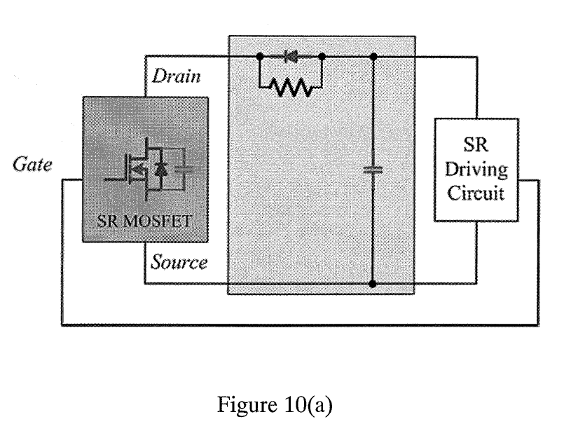

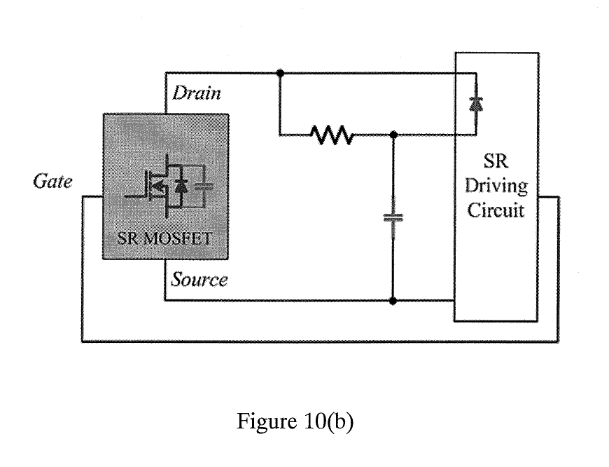

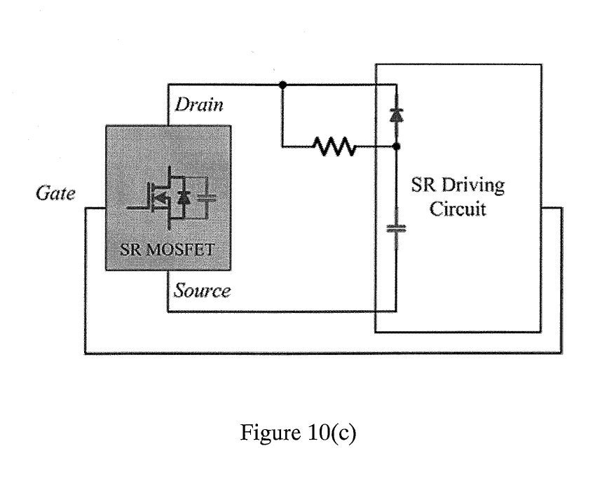

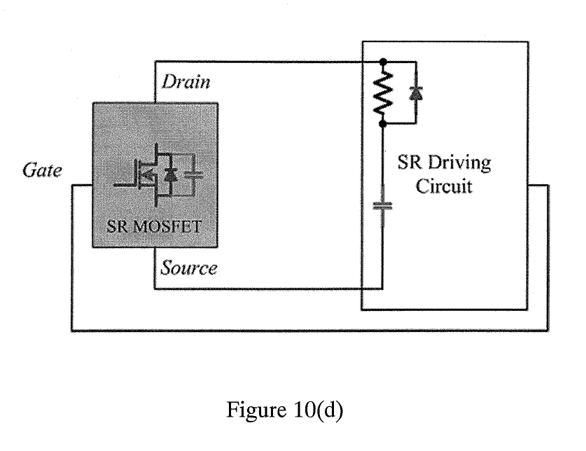

It will be appreciated that a non-linear compensation circuit as described herein may be implemented separately from the SR driving circuit, or partially or fully combined with the SR driving circuit. For example, FIGS. 10(a) to 10(d) show simplified diagrams of various embodiments in which the non-linear compensation circuit is implemented separately from the SR driving circuit (FIG. 10(a)), partially combined with the SR driving circuit (FIGS. 10(b) and 10(c)), and fully combined with the SR driving circuit (FIG. 10(d)). The SR driving circuit, either alone or partially or fully implemented with the non-linear compensation circuit, may be fabricated using discrete components or using any suitable integrated circuit (IC) technology.

Embodiments are further described by way of the following non-limiting example.

### Example

### Simulation and Experimental Results

An embodiment of a half bridge LLC resonant converter with SRs and non-linear compensation circuit, based on the circuit shown in FIG. 5(b), was built and tested, and a simulation was also conducted using simulation software (Saber version 4.0, Synopsys, Inc., Mountain View, Calif.). In the simulation and the experimental embodiment, the converter was 400V/12V, 600W, and the parameters were as listed in Table 1.

TABLE 1
CIRCUIT PARAMETERS

| | | | |
|---|---|---|---|
| Lₘ (μH) | 98.7 | C_{S} (nF) | 40 |
| L_{LKP} (μH) | 6.8 | R_{filter} (kΩ) | 3.9 |
| L_{LKS} (nH) | 9 | C_{filter} (pF) | 100 |
| D_{filter} | 1N4148 | | |
| SR driving | IR1168 | Q_{H}, Q_{L} | IPB50R299 |
| Turns ratio | 20:1:1 | Q_{S1}, Q_{S2} | SIR158DP |

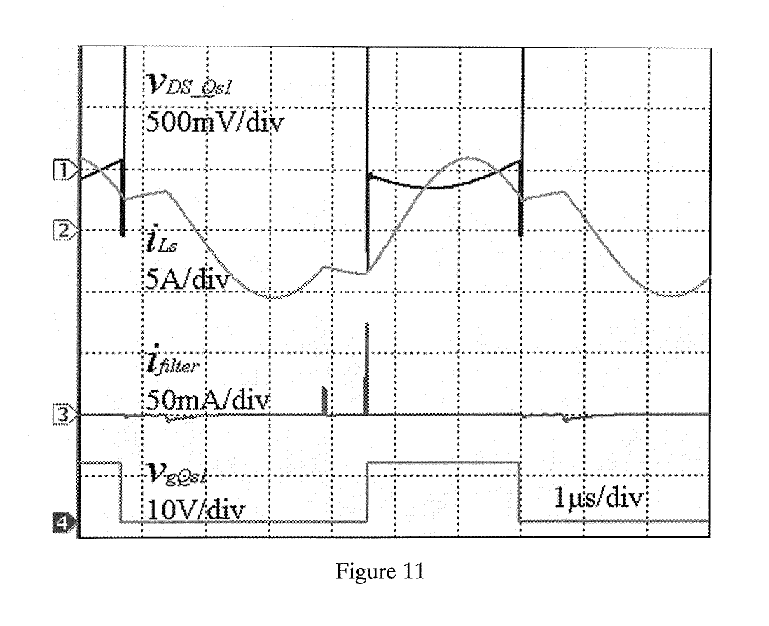

FIG. 11 shows the simulation results for v_{DS}, the current of the resonant tank, and the current through the non-linear compensation circuit. It is observed that the extra loss of the non-linear compensation circuit is very small. A short delay at the switch on and a lead time at the switch off are provided to prevent an energy reversal from the output capacitor to the source. Because of the small turn on and turn off currents of the SR, the conduction loss of the body diode may be neglected.

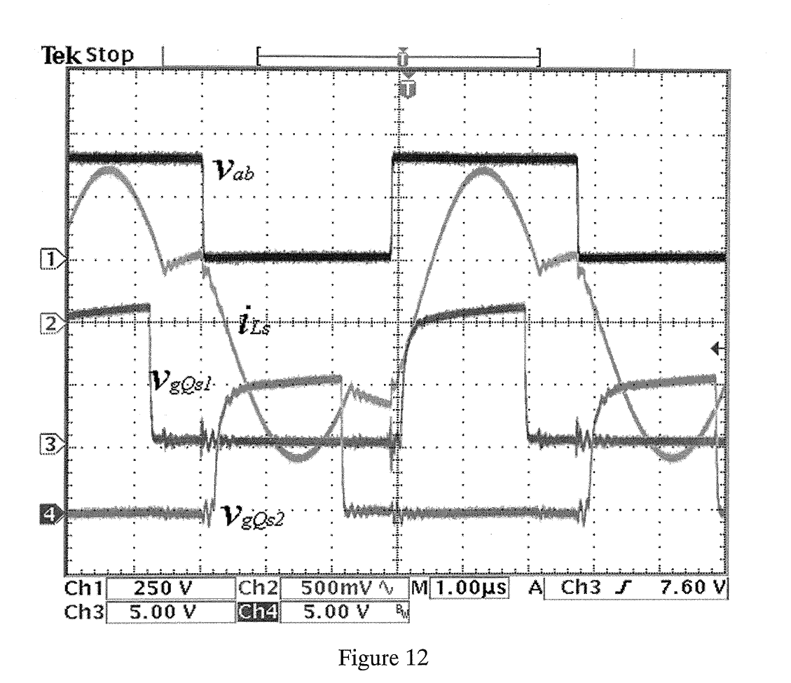

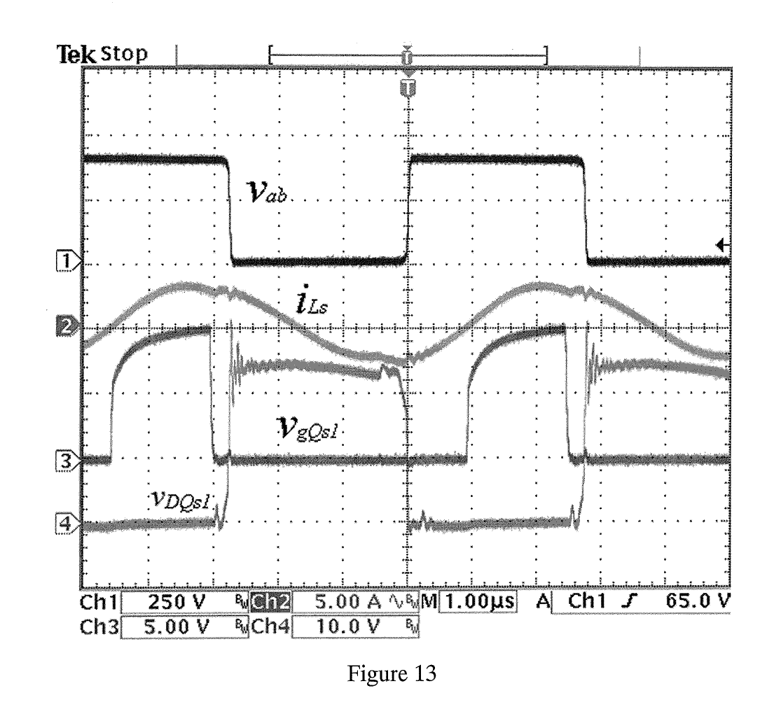

FIGS. 12 and 13 show waveforms of the experimental embodiment at full load and light load conditions, respectively. These results show that the embodiment operates properly at any load condition.

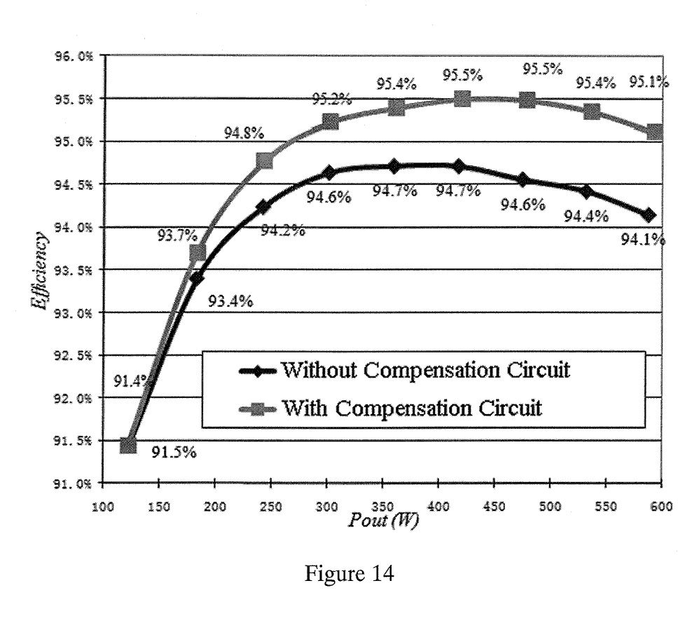

FIG. 14 compares the measured efficiency of the experimental embodiment with and without the non-linear compensation circuit under different load conditions. It can be seen that as the load current increases, the efficiency improvement resulting from the non-linear compensation circuit becomes more significant.

All cited publications are incorporated herein by reference in their entirety.

### EQUIVALENTS

Those skilled in the art will recognize or be able to ascertain equivalents to the embodiments described herein. Such equivalents are considered to be encompassed by the invention and are covered by the appended claims.

### REFERENCES

[1] A. Lokhandwala, M. Salato, and M. Soldano, “Dual SmartRectifier and DirectFET Chipset Overcomes Package Source Inductance Effects and Provides Accurate Sensing for Synchronous Rectification in DC-DC Resonant Converters,” in Proc. IEEE Appl. Power Electron. Conf., 2007, pp. 1559-1562.
[3] B. Wang, X. Xin, S. Wu, et al., “Analysis and Implementation of LLC Burst Mode for Light Load Efficiency Improvement,” in Proc. IEEE Appl. Power Electron. Conf., 2009, pp. 58-64.
[4] D. Fu, Y. Liu, F. C. Lee, et al., “A Novel Driving Scheme for Synchronous Rectifiers in LLC Resonant Converters,” IEEE Trans. Power Electron., vol. 24, no. 5, pp. 1321-1329, 2009.
[5] G. Zhang, J. Zhang, C. Zhao, et al., “LLC resonant DC/DC converter with current-driven synchronized voltage-doubler rectifier,” in Proc. IEEE Energy Cony. Cong. Expos., 2009, pp. 744-749.
[6] B. Yuan, M. Xu, X. Yang, et al., “A new structure of LLC with primary current driven synchronous rectifier,” in Proc. IEEE Power Electron. Motion Control Conf., 2009, pp. 1266-1269.
[7] C. Zhao, B. Li, J. Cao, et al., “A novel primary current detecting concept for synchronous rectified LLC resonant converter,” in Proc. IEEE Energy Cony. Cong. Expos., 2009, pp. 766-770.
[8] X. Xie, J. C. P. Liu, F. N. K. Poon, et al., “A novel high frequency current-driven synchronous rectifier applicable to most switching topologies,” IEEE Trans. Power Electron., vol. 16, no. 5, pp. 635-648, 2001.
[9] R. Lenk, “Application Bulletin AB20 Optimum Current-Sensing Techniques in CPU Converters,” Fairchild Semiconductor Application Notes, 1999.
[10] E. Dallago, M. Passoni, and G. Sassone, “Lossless current sensing in low-voltage high-current DC/DC modular supplies,” IEEE Trans. Ind. Electron., vol. 47, no. 6, pp. 1249-1252, 2000.
[11] H. P. Forghani-zadeh and G. A. Rincon-Mora, “Current-sensing techniques for DC-DC converters,” in Proc. Circuits and Systems, 2002. MWSCAS-2002. The 2002 45th Midwest Symposium on, 2002, pp. 11-577-11-580 vol. 2.
[12] H. Lei and L. Shiguo, “Design considerations of time constant mismatch problem for inductor DCR current sensing method,” in Proc. IEEE AppL Power Electron. Conf., 2006, p. 7 pp.
[13] D. Yan, X. Ming, and F. C. Lee, “DCR Current Sensing Method for Achieving Adaptive Voltage Positioning (AVP) in Voltage Regulators with Coupled Inductors,” in Proc. IEEE Power Electron. Soc. Conf., 2006, pp. 1-7.
[14] H. Lei and L. Shiguo, “Design Considerations for Small Signal Modeling of DC-DC Converters Using Inductor DCR Current Sensing Under Time Constants Mismatch Conditions,” in Proc. IEEE Power Electron. Soc. Conf., 2007, pp. 2182-2188.

1. A method for improving a driving signal of a driver for a synchronous rectifier (SR) of a power converter, comprising:
connecting a non-linear compensation circuit in parallel with the SR;
sensing a voltage of the non-linear compensation circuit; and
outputting the sensed voltage to the SR driver;
wherein the SR driver generates a driving signal for the SR based on the sensed voltage.

2. The method of claim 1, wherein the circuit compensates voltage across the SR.

3. The method of claim 1, wherein the non-linear compensation circuit is a passive circuit.

4. The method of claim 3, wherein the non-linear compensation circuit comprises:
a capacitor having a first terminal connected to a first terminal of the SR; and
a combination of a diode and a resistor connected in parallel at first and second nodes, the first node connected in series with a second terminal of the capacitor and the second node connected to a second terminal of the SR.

5. The method of claim 4, wherein the SR is a device selected from a MOSFET, a MESFET, and a JFET.

6. The method of claim 5, wherein the SR is a MOSFET.

7. The method of claim 4, including selecting parameters of the resistor and the capacitor to match a trace inductance L_{trace} and R_{Ds}_{_{—}}ₒₙ of the SR.

8. The method of claim 1, wherein the driving signal for the SR substantially prevents false-triggering of the SR.

9. The method of claim 1, wherein the resonant converter is a LLC resonant converter, a series resonant converter, or a flyback converter.

10. The method of claim 1, wherein the SR driver is a conventional SR driver.

11. The method of claim 1, including at least partially integrating the non-linear compensation circuit with the SR driver.

12. A circuit for use with a synchronous rectifier (SR) driver of a power converter, comprising:
a non-linear compensation circuit connected across the SR;
wherein a voltage of the non-linear compensation circuit is outputted to the SR driver and used by the SR driver to generate a driving signal for the SR.

13. The circuit of claim 12, wherein the non-linear compensation circuit is passive.

14. The circuit of claim 12, wherein the non-linear compensation circuit comprises:
a capacitor having a first terminal connected to a first terminal of the SR; and
a combination of a diode and a resistor connected in parallel at first and second nodes, the first node connected in series with a second terminal of the capacitor and the second node connected to a second terminal of the SR.

15. The circuit of claim 14, wherein parameters of the resistor and the capacitor are selected to match a trace inductance L_{trace} and R_{Ds}_{_{—}}ₒₙ of the SR.

16. The circuit of claim 12, wherein the driving signal for the SR substantially prevents false-triggering of the SR.

17. The circuit of claim 12, wherein the resonant converter is a LLC resonant converter, a series resonant converter, or a flyback converter.

18. The circuit of claim 12, wherein the resonant converter is a LLC resonant converter.

19. The circuit of claim 12, wherein the SR driver is a conventional SR driver.

20. The circuit of claim 1, wherein the non-linear compensation circuit is at least partially integrated with the SR driver.

21. The circuit of claim 12, wherein the SR is a device selected from a MOSFET, a MESFET, and a JFET.

22. The circuit of claim 12, wherein the SR is a MOSFET.

23. A synchronous rectifier (SR) for a resonant converter, comprising:
a switch; and
a non-linear compensation circuit including a capacitor having a first terminal connected to a first terminal of the switch; and
a combination of a diode and a resistor connected in parallel at first and second nodes, the first node connected in series with a second terminal of the capacitor and the second node connected to a second terminal of the switch.

24. The synchronous rectifier of claim 23, further comprising a SR driver,
wherein a voltage of the non-linear compensation circuit is used by the SR driver to generate a SR driving signal.

25. The synchronous rectifier of claim 24, wherein the SR driver is a conventional SR driver.

26. The synchronous rectifier of claim 23, wherein the switch is a device selected from a MOSFET, a MESFET, and a JFET.

27. The synchronous rectifier of claim 23, wherein the switch is a MOSFET.
